(19) United States
(12) Patent Application Publication
(10) Pub. No.: US 2005/0148418 A1
(43) Pub. Date: Jul. 7, 2005

(54) Image capture device including elastic transmission apparatus

(76) Inventor: Kun-Yee Yang, Banciao City (TW)

Correspondence Address: Cynthia L. Pillote;Snell & Wilmer L.L.P., One Arizona Center, 400 East Van Buren, Phoenix, AZ, 85004-2202, US

(21) Appl. No.: 10/927,362

(22) Filed: Aug. 26, 2004

(30) Foreign Application Priority Data
Aug. 29, 2003 (TW) 92123912

(51) Int. Cl. F16H 7/12; F16H 7/22; F16H 59/00

(52) U.S. Cl. 474/101; 474/107; 474/117; 474/136; 474/138

(57) ABSTRACT

An image capture device including an elastic transmission apparatus is provided. The elastic transmission apparatus includes a motor providing power, a belt receiving and transmitting the power, a carriage connected with the belt, a passive pulley driven by the belt and an elastic element. The elastic element selectively provides an elastic force to the passive pulley to keep the carriage in a specific location so that the CIS module is firmly in contact with the window glass to ensure the scanning quality.

### CROSS-REFERENCE TO RELATED APPLICATIONS

This Application claims priority to Taiwan Patent Application No. 092123912 entitled “An Image Capture Device Including an Elastic Transmission Apparatus,” filed on Aug. 29, 2003.

### FIELD OF INVENTION

The present invention relates to an image capture apparatus including an elastic transmission device, and more particularly, to an image capture apparatus employing a contact image sensor, CIS.

### BACKGROUND OF THE INVENTION

A variety of optical components of image capture apparatus meet different functional requirements. The contact image sensors (CIS) are commonly used in thinner scanners or the ones that require shorter response time. Due to the small depth of focus (DOF) of the CIS component, the CIS component has to be kept as close to the window glass as possible to ensure better scanning quality. Keeping the CIS component firmly in contact with the window glass is key to ensuring image quality.

In prior art, providing an elastic force from an elastic element is a conventional method to keep the CIS component in contact with the window glass. As shown in FIG. 1a, the elastic element 101 here is a spring disposed between the CIS component 100 and the carriage 102, and the CIS module 105 includes the CIS component 100 and the carriage 102. The elastic element 101 provides an elastic force to keep the CIS component close to the window glass. In FIG. 1, a guide hole 103 is connected with a guide shaft (not illustrated) to move the carriage 102. In some variations of the prior art, the elastic element 101 is disposed outside the carriage 102 to achieve the same effect.

FIG. 1b shows a schematic diagram of the movement of CIS module in prior art. The motor 107 drives the belt 109 to move the CIS module 105. The image capture apparatus 110 is composed of the CIS module 105 and the support device 111. A pulley 106 is disposed at the opposite side of the motor 107 to help the belt 109 move smoothly. As shown in FIG. 1b, a guiding shaft 108 is disposed opposite the belt 109 and at the other side of the CIS module to guide the CIS module 105.

### SUMMARY OF THE INVENTION

One aspect of the present invention is to provide an image capture apparatus including an elastic transmission device, and the transmission device drives and provides a support force to the image sensor apparatus to keep the CIS component firmly in contact with the window glass of the image capture apparatus.

The transmission device of the image capture apparatus of the present invention includes a motor providing the power, a belt receiving and transmitting the power, a support device connected with the belt, a passive pulley driven by the belt and an elastic element. The elastic element selectively provides an elastic force to keep the support device at a specific position so that the scanning quality can be assured by keeping the CIS module firmly in contact with the window glass of the image capture apparatus.

The transmission device of the image capture apparatus of the present invention provides several advantages. It keeps the CIS module firmly in contact with the window glass by an elastic force from the elastic element, reduces the product size and lowers the production cost by replacing the conventional elastic element and transmission device in the prior art.

### BRIEF DESCRIPTION OF THE DRAWINGS

FIG. 1a shows a schematic diagram of a prior art CIS module.

FIG. 1b shows a schematic diagram of the movement of a prior art CIS module.

FIG. 2a shows a side view of a transmission device in accordance with one embodiment of the present invention.

FIG. 2b shows a detailed side view of the embodiment in FIG. 2a.

FIG. 2c shows a side view of a transmission device in accordance with another embodiment.

FIG. 3 shows a side view of the transmission device of another embodiment of the present invention.

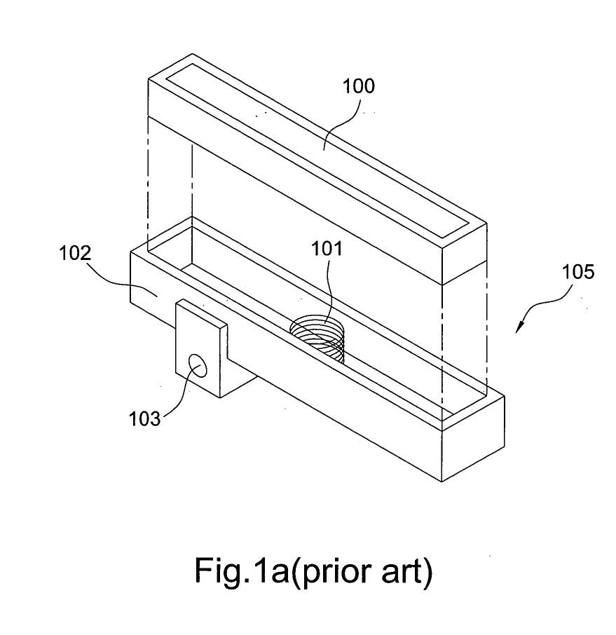

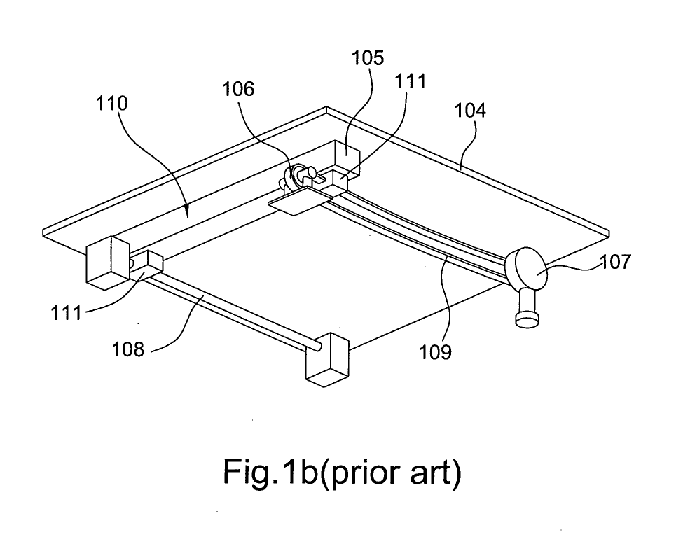

### DETAILED DESCRIPTION

The present invention provides an image capture apparatus including an elastic transmission device with both transmission and support functions. The preferred embodiment of the present invention is used in an image capture apparatus with a CIS component. However, the present invention can also be used in other image capture apparatus that require transmission and support.

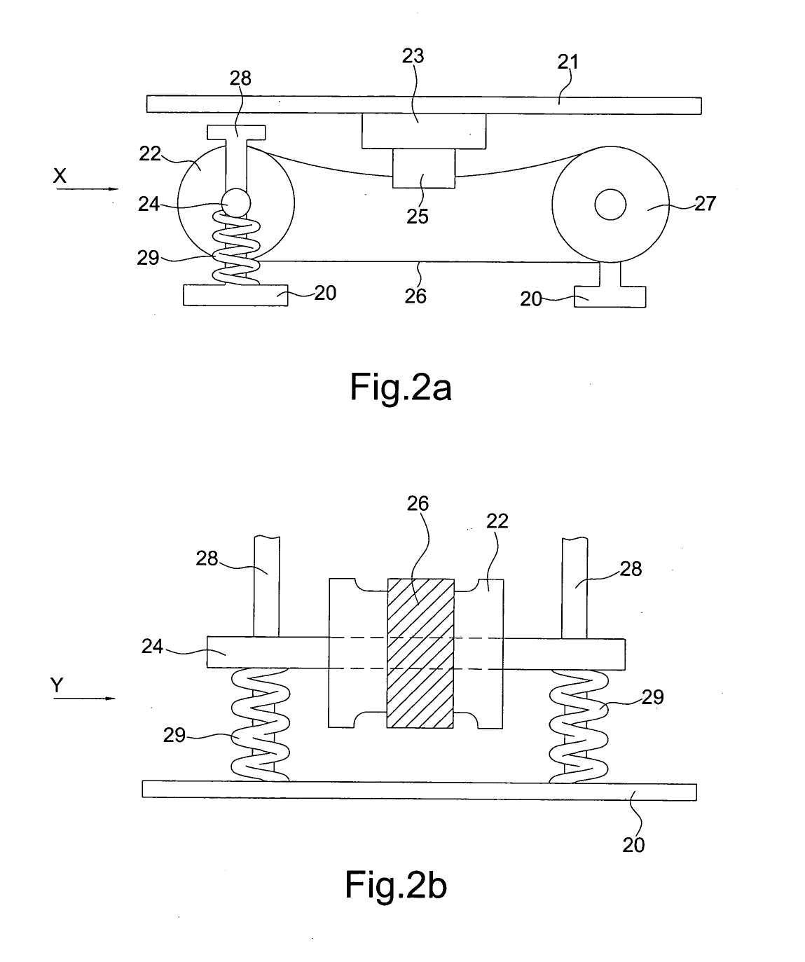

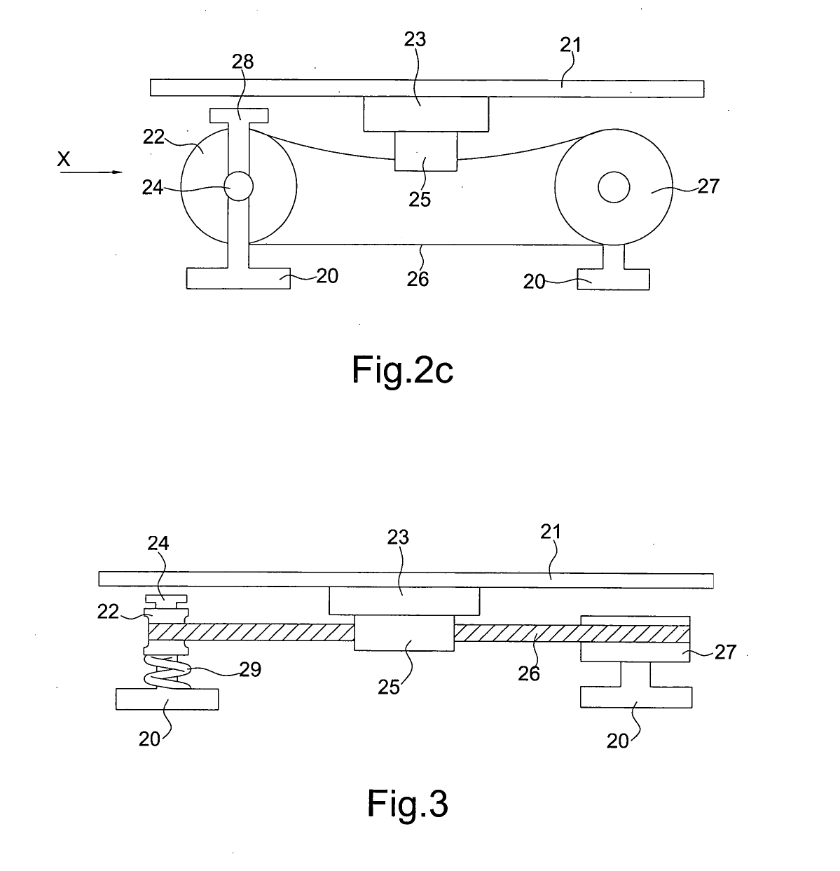

FIG. 2a shows a side view of a transmission device of one embodiment of the present invention. As shown in FIG. 2a, the transmission device includes a motor 27 providing the power, a belt 26 receiving and transmitting the power, a support device 25 connected with the belt 26, a passive pulley 22 driven by the belt 26, and an elastic element 29. The elastic element 29 encloses the support component 28, and the support component 28 is connected with the base 20 thereunder. The projection portion on the support component 28 limits the movement of the passive pulley 22. In this embodiment, the belt 26 could be a leather belt, a steel wire or the like. The axial column 24 of the fore mentioned passive pulley 22 vertically movably wraps around the support component 28. The elastic element 29 provides an upward elastic force to the belt 26 via the axial column 24 of the passive pulley 22, enabling the passive pulley 22 to exert an upward elastic force on the belt 26, which in turn transmits the force to the support device 25. The support device 25 then keeps the CIS module firmly in contact with the window glass 21 to ensure the scanning quality of the image capture apparatus. The elastic element 29 here is a spring, but it could be a functional equivalent in other embodiments. The foregoing CIS module 23 is composed of the CIS component 100 and the carriage 102, or it can be a structure combing the two. The aforementioned support device 25 is a structure disposed under the CIS module 23 and connected with the belt 26. In another embodiment, the support device 25 and the CIS module 23 can be integrated into a single structure.

FIG. 2b shows a detailed side view of the embodiment in FIG. 2a, the observation direction being the X direction. As shown in FIG. 2b, the belt 26 drives the passive pulley 22. An axial column 24 stretches out in the axial direction of the passive pulley 22, and the axial column 24 vertically movably wraps around the support component 28, which is connected with the base 20. The elastic element 29 encloses the support component 28 and provides an upward elastic force, via the axial column 24 and the belt 26, to the passive pulley 22 to keep the support device 25 at a fixed position, which in turn keeps the CIS module 23 firmly in contact with the window glass 21 and ensures scanning quality of the image capture apparatus (not illustrated).

FIG. 2c shows a side view of a transmission device in accordance with another embodiment. As shown in FIG. 2c, the transmission device includes a motor 27 providing the power, a belt 26 receiving and transmitting the power, a support device 25 connected with the belt 26 and a passive pulley 22 driven by the belt 26. The passive pulley 22 is disposed immovably here. The relative positions of the passive pulley 22, the motor 27 and the support device 25 are arranged in a way such that the belt 26 can provide an upward tension to the support device 25. The forgoing tension of the belt 26 keeps the CIS module 23 firmly in contact with the window glass 21 to ensure the scanning quality of the image capture apparatus. In this embodiment, the belt 26 could be a leather belt, a steel wire or the like. The foregoing CIS module 23 is composed of the CIS component 100 and the carriage 102, or it can be a structure combing the two. The aforementioned support device 25 is a structure disposed under the CIS module 23 and connected with the belt 26. In another embodiment, the support device 25 and the CIS module 23 can be integrated into one single structure.

FIG. 3 shows a side view of the transmission device of another embodiment of the present invention. As shown in FIG. 3, the transmission device also includes a motor 27 providing the power, a belt 26 receiving and transmitting the power, a support device 25 connected with the belt 26, a passive pulley 22 driven by the belt 26 and an elastic element 29. In this embodiment, the belt 26 could be a leather belt, a steel wire or the like. The main feature of this embodiment is that the support component of the elastic element 22 and the axial column 24 of the passive pulley 26 are integrated into one structure, with the elastic element 29 enclosing the axial column 24 and the axial column 24 connected with the base 20. The elastic element 29 provides an upward elastic force to the passive pulley 22 to form an elastic-force provider to provide an upward elastic force to the belt 26. The support device 25 receives an upward support force parallel to the axial direction via the tension transmitted by the belt 26. Thus the CIS module 23 is kept firmly in contact with the window glass 21 to ensure the scanning quality of the image capture apparatus. The elastic element 29 here is a spring, but it could be a functional equivalent in other embodiments. The foregoing CIS module 23 is composed of the CIS component 100 and the carriage 102, or it can be a structure combining the two. The aforementioned support device 25 is a structure disposed under the CIS module 23 and connected with the belt 26. In another embodiment, the support device 25 and the CIS module 23 can be integrated into one single structure.

As shown in FIGS. 2a-2c, the elastic element 29 in the embodiment of FIG. 3 could be removed and then it is the tension of the belt 26 that provides the only upward elastic-force to the support device 25 (not illustrated). The concept is similar to the embodiment in FIG. 2c and won't be repeated here.

While the invention has been described in connection with what is presently considered to be the most practical and preferred embodiments, it is to be understood that the invention is not to be limited to the discovered embodiments. The invention is intended to cover various modifications and equivalent arrangements included within the spirit and scope of the appended claims.

1. An image capture apparatus comprising:
a window glass;
an image sensor module under the windows glass; and
a transmission device, further comprising:
a belt connected with the image sensor module;
a passive pulley vertically movably disposed under the window glass, the passive pulley driven by the belt; and
an elastic element, the elastic element selectively providing an upward elastic force to the passive pulley to keep the image sensor module contacting with the window glass.

2. The image capture apparatus according to claim 1, further comprising a guiding shaft to guide the image sensor module.

3. The image capture apparatus according to claim 1, further comprising a support component, wherein the passive pulley includes an axial column disposed on a center of the passive pulley and passing through the passive pulley, and the axial column is movably connected with the support component, and the upward elastic force allows the passive pulley moving vertically along the support component.

4. The image capture apparatus according to claim 1, wherein the passive pulley includes an axial column disposed on a center of the passive pulley and passing through the passive pulley, and the upward elastic force allows the passive pulley moving vertically along the axial column.

5. The image capture apparatus according to claim 1, wherein the elastic force is perpendicular to an axis of the passive pulley.

6. The image capture apparatus according to claim 1, wherein the elastic force parallels an axis of the passive pulley.

7. The image capture apparatus according to claim 1, wherein the belt includes a steel wire.

8. An image capture apparatus comprising:
a window glass;
an image sensor module under the windows glass;
a belt connected with the image sensor module;
a transmission pulley, vertically movably disposed under the window glass and connected with the belt; and
an elastic element, the elastic element selectively providing an upward elastic force to the transmission pulley to keep the image sensor module contacting with the window glass.

9. The image capture apparatus according to claim 8, further comprising a support component, wherein the transmission pulley includes an axial column disposed on a center of the transmission pulley and passing through the transmission pulley, and the axial column is movably connected with the support component, and the upward elastic force allows the transmission pulley moving vertically along the support component.

10. The image capture apparatus according to claim 8, wherein the transmission pulley includes an axial column disposed on a center of the transmission pulley and passing through the transmission pulley, and the upward elastic force allows the transmission pulley moving vertically along the axial column.

11. The image capture apparatus according to claim 8, wherein the elastic force is perpendicular to an axis of the transmission pulley.

12. The image capture apparatus according to claim 8, wherein the elastic force parallels an axis of the transmission pulley.

13. The image capture apparatus according to claim 8, wherein the belt includes a steel wire.

14. The image capture apparatus according to claim 8, wherein the image sensor module includes a support device and a contact image sensor module support by the support device.

15. An image capture apparatus comprising:
a window glass;
an image sensor module under the windows glass;
a belt connected with the image sensor module; and
an elastic device, the elastic device selectively providing an upward elastic force to the belt to keep the image sensor module contacting with the window glass.

16. The image capture apparatus according to claim 15, wherein the image sensor module further comprises:
a contact image sensor module; and
a support device disposed under the contact image sensor module, the support device connected with the belt.

17. The image capture apparatus according to claim 15, further comprising a guiding shaft to guide the image sensor module.

18. The image capture apparatus according to claim 15, wherein the elastic device includes a passive pulley and an elastic element.

19. The image capture apparatus according to claim 18, further comprising a support component, wherein the passive pulley includes an axial column disposed on a center of the passive pulley and passing through the passive pulley, and the axial column is movably connected with the support component, and the upward elastic force allows the passive pulley moving vertically along the support component.

20. The image capture apparatus according to claim 15, wherein the passive pulley includes an axial column disposed on a center of the passive pulley and passing through the passive pulley, and the axial column is connected with the housing, and the upward elastic force allows the passive pulley moving vertically along the axial column.
